(19) United States
(12) Patent Application Publication
(10) Pub. No.: US 2013/0292242 A1
(43) Pub. Date: Nov. 7, 2013

(54) DEVICE AND METHOD FOR DISTILLING TEMPERATURE-SENSITIVE SUBSTANCES

(71) Applicants: Dieter Hietsch, Illertissen (DE); Peter Horlacher, Bellenberg (DE); Joerg Schwarzer, Hilden (DE)

(72) Inventors: Dieter Hietsch, Illertissen (DE); Peter Horlacher, Bellenberg (DE); Joerg Schwarzer, Hilden (DE)

(73) Assignee: Cognis IP Management GmbH, Dusseldorf (DE)

(21) Appl. No.: 13/879,040

(22) PCT Filed: Sep. 23, 2011
(86) PCT No.: PCT/EP2011/004760

§ 371 Date: Jul. 22, 2013

(30) Foreign Application Priority Data
Oct. 13, 2010 (EP) EP10187409

(51) Int. Cl. B01D 3/14

(52) U.S. Cl. CPC B01D 3/148
USPC 203/87; 202/153

(57) ABSTRACT

The present invention relates to an apparatus for the distillation of substance mixtures which comprise temperature-sensitive substances, where the apparatus comprises a thin-film evaporator and a fractionating column, and where the fractionating column is attached to the distillate outlet of the thin-film evaporator, and where the fractionating column has at least 3 theoretical plates, and where the pressure drop of the fractionating column during operation at an F factor of 1 Pa^{1/2} amounts to a maximum of 3 hPa (3 mbar). Furthermore, the present invention relates to a process for the distillation of substance mixtures which comprise temperature-sensitive substances, which process is carried out in the apparatus according to the invention.

The present invention relates to an apparatus for the distillation of substance mixtures which comprise temperature-sensitive substances, where the apparatus comprises a thin-film evaporator and a fractionating column, and where the fractionating column is attached to the distillate outlet of the thin-film evaporator, and where the fractionating column has at least 3 theoretical plates, and where the pressure drop of the fractionating column during operation at an F factor of 1 Pa^{1/2} amounts to a maximum of 3 hPa (3 mbar). Furthermore, the present invention relates to a process for the distillation of substance mixtures which comprise temperature-sensitive substances, which process is carried out in the apparatus according to the invention.

Apparatuses and processes for the distillation of temperature-sensitive substances are known. An example of such a process is short-path distillation, also referred to as molecular distillation. Suitable apparatuses for the distillation of temperature-sensitive substances are, for example, thin-film evaporators. References to both can be found in the online Chemielexikon Römpp [Chemistry Dictionary] Online, Version 3.7 under the key words “Destillation” [Distillation] and “Dünnschichtverdampfer” [thin-film evaporators].

Temperature-sensitive substances of interest include, in particular, the polyunsaturated fatty acids and their derivatives, for example their methyl esters or ethyl esters.

Polyunsaturated fatty acids are fatty acids which comprise at least two double bonds. They include, for example, linoleic acid, alpha-linolenic acid, gamma-linolenic acid and arachidonic acid. Polyunsaturated fatty acids have at least five C atoms. In what follows, polyunsaturated fatty acids are understood as meaning in particular those which have at least six C atoms. The polyunsaturated fatty acids also include omega-3-fatty acids. EPA and DHA are specific omega-3-fatty acids.

EPA is the abbreviation for (5Z,8Z,11Z,14Z,17Z)-eicosa-5,8,11,14,17-pentaenoic acid. DHA is the abbreviation for (4Z,7Z,10Z,13Z,16Z, 19Z)-docosa-4,7,10,13,16,19-hexaenoic acid.

Polyunsaturated fatty acids, in particular EPA and DHA, can be employed as components of foodstuffs, in dietary supplements or in what is known as functional foods. They can also be employed in the pharmaceutical sector, for example in the case of EPA and DHA for the therapy or prophylaxis of coronary heart disease. In most cases, they are employed as glycerol esters, that is to say as a component of fats. However, they may also be employed as free fatty acids or in the form of esters, for example ethyl esters.

Polyunsaturated fatty acids, in particular EPA and DHA, can be obtained from natural sources, for example from fish oil. Providing highly concentrated polyunsaturated fatty acids, in particular EPA and DHA, requires processes for concentrating polyunsaturated fatty acids, in particular EPA and/or DHA, by means of which polyunsaturated fatty acids, in particular EPA and/or DHA, can be concentrated from natural sources such as, for example, fish oil.

The concentration of polyunsaturated fatty acids by crystallization methods is known from the prior art.

Acta Chemica Scandinavia 17 (1963) No. 10, pages 2622 to 2627: “Fractionation of Linseed Oil Fatty Acids by Crystallisation” discloses a crystallization in two steps, the first step being carried out at −25° C. and the second at −40° C. The medium used is methanol. This process allows a concentration of C 18:2.

DE 969 103 discloses the concentration of EPA and of DHA starting from solid sodium soaps by using organic solvents in which the sodium soaps are not soluble while the other accompanying substances are soluble.

GB 719 513 discloses a process in which the saponification of fats and oils generates soaps which, in turn, are converted into solid substances. Thereafter, the unsaturated soaps are dissolved using water-miscible organic solvents.

The European patent application with the application number 10001000 (internal file reference of Cognis IP Management GmbH: C 3494), too, discloses a process for concentrating EPA and DHA.

The concentration of ethyl esters of EPA and DHA by means of short-path distillation is known from the prior art, too, for example from Harald Breivik in “Long-Chain Omega-3 Speciality Oils”, Volume 21 (2007) in The Oily Press Lipid Libary, pages 111-140, which also discloses other concentration methods for EPA and DHA and for EPA and DHA derivatives, for example urea complexation, processes which exploit supercritical solvents, and enzymatic concentration processes.

The present invention is based on the aim of providing a further apparatus and a further process for the distillation of temperature-sensitive substances.

This aim is achieved by the apparatus and by the process according to the independent patent claims. In this context, the apparatus according to the invention and the process according to the invention may be employed for distilling temperature-sensitive substances in general. Depending on the substance mixture which is present, the distillation allows a concentration of the temperature-sensitive substances to be obtained either as the top product or as the bottom product of the distillation. Naturally, one may also refer to a purification or separation instead of a distillation or concentration of the temperature-sensitive substances.

The F factor with the unit Pa^{1/2} is explained for example in Ullmann's Encyclopedia of Industrial Chemistry, online-Version, Release 2010, 7th Edition, in the chapter “Distillation, 2. Equipment” under item 2.2, pages 3 to 6.

Subject matter of the dependent claims are specific embodiments of the present invention.

In one embodiment of the present invention, the fractionating column is a column with structured packing. Columns with structured packings are illustrated for example in Ullmann's Encyclopedia of Industrial Chemistry, online-Version, Release 2010, 7th Edition, in the chapter “Distillation, 2. Equipment” under item 3, pages 12 to 21.

In one embodiment of the present invention, the thin-film evaporator is a wiped film evaporator.

In one embodiment of the present invention, the thin-film evaporator is a wiped rotary film evaporator.

Film evaporators are illustrated for example in Ullmann's Encyclopedia of Industrial Chemistry, online-Version, Release 2010, 7th Edition, in the chapter “Heat Exchange” under item 2.2.2.1, pages 22 to 25.

In one embodiment of the present invention, the process according to the invention is carried out in such a way that the F factor amounts to a maximum of 2 Pa^{1/2}, preferably a maximum of 1.5 Pa^{1/2}, in particular to a maximum of 1.1 Pa^{1/2}.

In one embodiment of the present invention, the apparatus according to the invention is configured such that it is possible to feed an entrainer into the film evaporator. Suitable entrainers are, in particular, water, steam, nitrogen or carbon dioxide. In one embodiment of the present invention, accordingly, the process according to the invention is carried out in such a way that an entrainer is fed into the film evaporator, which entrainer may be in particular water, steam, nitrogen or carbon dioxide. The purpose of the entrainer can be in particular to facilitate the distillative separation of the components of the substance mixture which comprises temperature-sensitive substances and also to contribute to avoiding the thermal decomposition of the temperature-sensitive substances.

The present invention has been developed in particular with the example of polyunsaturated fatty acids and their derivatives, in particular with the example of the methyl esters or the ethyl esters of EPA and of DHA. However, the apparatus according to the invention and the process according to the invention may also be applied to other temperature-sensitive substances and/or employed for concentrating or purifying such substances.

The process according to the invention makes possible in particular the preparation of highly concentrated EPA and/or DHA products starting from fish oils.

The EPA and/or DHA products prepared by the process according to the invention can be used in the pharmaceutical sector, in the food supplement market and as what is known as “infant nutrition”.

In the event that a mixture which, besides other fatty acids from fish oils, comprises EPA and DHA, or in the event that methyl or ethyl esters of the abovementioned fatty acid mixtures are distilled, the process according to the invention permits highly concentrated EPA and DHA products to be prepared. This results in a substantial depletion of DHA in the distillate and a substantial concentration of DHA in the residue.

The process according to the invention has many advantages. Those which should be mentioned in particular are short residence times of the temperature-sensitive substances to be distilled. Others which must be mentioned are high yields and a simplified process in comparison with the known molecular distillation. Furthermore, decomposition of the temperature-sensitive substances to be distilled, as might take place in traditional distillation columns for fractional distillation, is largely avoided.

The apparatus according to the invention and the process according to the invention allow the largely decomposition-free distillation of temperature-sensitive substances in particular because relatively short fractionating columns with a relatively large diameter may be employed and because the process may be carried out at a low throughput and a low top vacuum.

### EXAMPLES

### Distillation of Fatty Acid Ethyl Esters

In what follows, % means GC area% of the fatty acid ethyl esters (GC=gas chromatography).

The distillation apparatus used was a distillation apparatus according to the invention as described hereinbelow in key words. The operating parameters specified hereinbelow were used:
vacuum system: rotary vane pump with a pressure at the top of approx. 0.6-0.7 mbar (1 mbar=1 hPa)
glass mirrored fractionating column (Dewar), diameter of the packing: 75 mm, length of the packing: 510 mm, packing type: Sulzer BX
top of the column equipped with total condenser and pulsed run back divider (run back ratio 1:1)
evaporator at the bottom: glass film evaporator, diameter 55 mm, length of the evaporation surface: 430 mm (approx. 0.074 m²)
heating with heat transfer oil: between 175 and 200° C. (preferably 190-195° C.)
feed from dropping funnel approx. 300 ml/h
the start-up product from the bottom was kept separately until overhead product was obtained
the shutdown product=content of the packing was combined with the bottom product

The substance mixture before the distillation consisted to approx. 90-95% of fatty acid ethyl esters of chain length C14 to C24 with different number of double bonds and to 5-10% of mono-, di- and triglycerides of the same fatty acids. EPA ethyl esters and DHA ethyl esters were present in the mixture in particular. The lower-boiling compounds were concentrated in the distillate during the distillation, while the higher-boiling compounds remained in the distillation bottoms. The partitioning into the two components was controlled in particular by the amount of heat introduced. Particularly good control was effected on the partitioning of the EPA ethyl esters into distillate and residue.

The following results were obtained. In this context, the “cut” indicates the proportion of distillate to residue. In the first line of the following example, for example, “Distillate cut 46%” and “Residue cut 54%” mean that the distillate amounts to 46% and the residue amounts to 54% of the starting material.

| | Feed | | Distillate | | | Residue | | |
|---|---|---|---|---|---|---|---|---|
| Experiment | EPA | DHA | Cut | EPA | DHA | Cut | EPA | DHA |
| EE3322_1 | 35.9% | 25.9% | 46% | 52.7% | 0.0% | 54% | 17.0% | 50.2% |
| EE3322_2 | 34.4% | 23.7% | 51% | 42.8% | 0.0% | 49% | 27.5% | 39.5% |
| EE3426_1 | 36.6% | 25.7% | 46% | 53.7% | 0.0% | 54% | 18.5% | 46.8% |
| EE1050_1 | 17.4% | 53.6% | 19% | 8.1% | 0.0% | 81% | 11.6% | 64.8% |
| EE1050_2 | 16.6% | 51.9% | 28% | 43.0% | 0.1% | 72% | 11.4% | 62.9% |
| EE1020_1 | 12.9% | 20.8% | 67% | 1.2% | 0.0% | 33% | 12.0% | 63.2% |
| EE1020_2 | 13.0% | 21.2% | 65% | 3.9% | 0.2% | 35% | 16.3% | 58.7% |

These results demonstrate that it was possible to achieve a concentration of EPA in the distillate without DHA going over simultaneously. This, therefore, offers the possibility of generating EPA-rich distillates. However, it is also possible to obtain DHA-rich concentrates in high yields. No thermal decomposition of the products was observed.

1-15. (canceled)

16. An apparatus for the distillation of substance mixtures which comprise temperature-sensitive substances, where the apparatus comprises a thin-film evaporator and a fractionating column, and where the fractionating column is attached to the distillate outlet of the thin-film evaporator, and where the fractionating column has at least 3, preferably at least 5, theoretical plates, and where the pressure drop of the fractionating column during operation at an F factor of 1 Pa^{1/2} amounts to a maximum of 3 hPa (3 mbar), preferably a maximum of 2 hPa, in particular a maximum of 1 hPa.

17. The apparatus according to claim 16, wherein the fractionating column is a column with structured mass transfer packing.

18. The apparatus according to claim 16, wherein the thin-film evaporator is a wiped film evaporator or a rotary thin-film evaporator.

19. The apparatus according to claim 16, wherein the apparatus makes it possible to feed the substance mixture to be separated into the film evaporator.

20. The apparatus according to claim 16, wherein the apparatus makes it possible to feed the substance mixture to be separated into the fractionating column, wherein preferential feeding into the middle of the column is possible.

21. The apparatus according to claim 16, wherein the apparatus furthermore comprises a pump for generating a vacuum in the apparatus, wherein the pump is preferably designed such that a vacuum of 3 hPa or a lower pressure, preferably 2 hPa or a lower pressure, in particular 1 hPa or a lower pressure, can be achieved.

22. A process for the distillation of substance mixtures which comprise temperature-sensitive substances, the process comprising distilling in the apparatus according to claim 16.

23. The process according to claim 22, wherein the substance mixture comprises polyunsaturated fatty acids or their methyl esters or their ethyl esters.

24. The process according to claim 23, wherein the substance mixture comprises omega-3-fatty acids or their methyl esters or their ethyl esters.

25. The process according to claim 24, wherein the substance mixture comprises EPA and DHA, both as the free fatty acid.

26. The process according to claim 25, wherein the substance mixture has been obtained by isolating the free fatty acids from a fish oil.

27. The process according to claim 24, wherein the substance mixture comprises EPA and DHA, both in the form of their ethyl esters.

28. The process according to claim 27, wherein the substance mixture has been obtained by converting the free fatty acids from a fish oil into their ethyl esters.

29. The process according to claim 25, wherein a product is obtained after the distillation which comprises at least 30% by weight, preferably at least 40% by weight, of EPA and a maximum of 10% by weight, preferably a maximum of 5% by weight, of DHA (in each case calculated as mass of free fatty acid based on the total mass of the product).

30. The process according to claim 25, wherein a product is obtained after the distillation which comprises at least 45% by weight, preferably at least 55% by weight, of DHA and a maximum of 20% by weight, preferably a maximum of 10% by weight, of EPA (in each case calculated as mass of free fatty acid based on the total mass of the product).

31. The use of an apparatus according to claim 16 for concentrating temperature-sensitive substances.
